(19) United States
(12) Patent Application Publication
(10) Pub. No.: US 2015/0249946 A1
(43) Pub. Date: Sep. 3, 2015

(54) NETWORK CONNECTION METHOD AND DEVICE SUPPORTING SAME

(71) Applicant: LG ELECTRONICS INC., Seoul (KR)

(72) Inventor: Hangseok Oh, Gyeonggi-do (KR)

(73) Assignee: LG Electronics Inc., Seoul (KR)

(21) Appl. No.: 14/427,383

(22) PCT Filed: Sep. 11, 2013
(86) PCT No.: PCT/KR2013/008215

§ 371 Date: Mar. 11, 2015

Related U.S. Application Data
(60) Provisional application No. 61/699,302, filed on Sep. 11, 2012.

(51) Int. Cl. H04W 36/14; H04W 4/00; H04W 36/00

(52) U.S. Cl. CPC H04W 36/14; H04W 36/0072; H04W 36/0066; H04W 4/008

(57) ABSTRACT

A network connection method and a device supporting the same are provided. A network connection method by which a first wireless communication device supporting a first network system and a second network system connects to a second wireless communication device may include: transmitting, to the second wireless communication device supporting the first networking system, a handover request message for requesting for information in order to connect to the second networking system by using an out of band channel of the first networking system; receiving, from the second wireless communication device, provisioning information on an authorization for forming a group in the second networking system in response to the handover request message; and transmitting and receiving additional information for connecting the second networking system to the second wireless communication device according to information included in a handover select message.

### FIELD OF THE INVENTION

The present invention relates to a network connection method and a device supporting the same, and most particularly, to a network connection method and a device for supporting the same that can transmit and receive a handover request message and a handover select message by using an out of band channel of an NFC (Near Field Communication) method.

### BACKGROUND ART

As wireless close-range communication technologies, such as Wi-Fi, and so on, have recently been extensively and broadly applied to the market, technologies for streaming Audio and Video by using Wi-Fi or controlling counterpart devices are being actively discussed.

However, due to the typical characteristic of Wi-Fi, which consumes a considerable amount of time for setting up (or establishing) connection between devices, the usage of Wi-Fi is disadvantageous in that is requires a large amount of time for establishing Wi-Fi connection.

### DETAILED DESCRIPTION OF THE INVENTION

### Technical Objects

An object of the present invention is to provide a network connection method and a device supporting the same.

Another object of the present invention is to provide a network connection method and a device for supporting the same that can transmit and receive a handover request message and a handover select message by using an out of band channel of an NFC (Near Field Communication) method.

The technical object that are to be achieve in the present invention will not be limited only to the technical objects described above. Accordingly, technical objects that have not been mentioned above or additional technical objects of the present application may become apparent to those having ordinary skill in the art from the description presented below.

### Technical Solutions

In order to resolve the above-describe problem, according to an exemplary embodiment of the present invention, a network connection method by which a first wireless communication device supporting a first networking system and a second networking system connects to a second wireless communication device includes the steps of transmitting, to the second wireless communication device supporting the first networking system, a handover request message for requesting for information in order to connect to the second networking system by using an out of band channel of the first networking system; receiving, from the second wireless communication device, provisioning information on an authorization for forming a group in the second networking system in response to the handover request message; and transmitting and receiving additional information for connecting the second networking system to the second wireless communication device according to information included in a handover select message.

The Handover Select message may further include channel information configured to decide a Group Owner in the second networking system.

The provisioning information may include credential information authorizing the first wireless communication device to access the second wireless communication device.

The provisioning information may include a device password.

The first networking system may include a NFC (Near Field Communication) method, and the second networking system may include a WiFi P2P method.

The Handover Select message may include connection time information on a time consumed for a connection of the second networking system.

The Handover Select message may include valid time information on a time period during which the provisioning information is valid.

The Handover Select message may further include channel information configured to form a group in the second networking system.

The Handover Select message may include information on a Basic Service Set of a network to which the second wireless communication device is connected.

The information on the Basic Service Set may include a MAC (Media Access Control) address of an owner device of the Basic Service Set.

According to another exemplary embodiment of the present invention, a first wireless communication device, which performs connection to a second wireless communication device, and which supports a first networking system and a second networking system, includes a RF (Radio Frequency) unit; and a processor, wherein the processor may be configured to transmit, to the second wireless communication device supporting the first networking system, a handover request message for requesting for information in order to connect to the second networking system by using an out of band channel of the first networking system, to receive, from the second wireless communication device, provisioning information on an authorization for forming a group in the second networking system in response to the handover request message, and to transmit and receive additional information for connecting the second networking system to the second wireless communication device according to information included in a handover select message.

The Handover Select message may further includes channel information configured to decide a Group Owner in the second networking system.

The provisioning information may include credential information authorizing the first wireless communication device to access the second wireless communication device.

The provisioning information may include a device password.

The first networking system may include a NFC (Near Field Communication) method, and the second networking system may include a WiFi P2P method.

The Handover Select message may include connection time information on a time consumed for a connection of the second networking system.

The Handover Select message may include valid time information on a time period during which the provisioning information is valid.

The Handover Select message may further include channel information configured to form a group in the second networking system.

The Handover Select message may include information on a Basic Service Set of a network to which the second wireless communication device is connected.

The information on the Basic Service Set may include a MAC (Media Access Control) address of an owner device of the Basic Service Set.

The above-described general description of the present invention and the detailed description of the present invention that will follow are merely exemplary, and, therefore, it should be understood that the description are provided for additional description on the appended claims of the present invention.

### Effects of the Invention

According to an exemplary embodiment of the present invention, a network connection method and a device supporting the same may be provided.

Additionally, according to an exemplary embodiment of the present invention, a network connection method and a device for supporting the same that can transmit and receive a handover request message and a handover select message by using an out of band channel of an NFC (Near Field Communication) method may be provided.

The effects of the present invention will not be limited only to the effects described above. Accordingly, effects that have not been mentioned above or additional effects of the present application may become apparent to those having ordinary skill in the art from the description presented below.

### BRIEF DESCRIPTION OF THE DRAWINGS

The accompanying drawings, which are included as a part of the detailed description in order to provide a further understanding of the present invention, provide exemplary embodiments of the present invention and describe the technical aspects of the present invention along with the detailed description.

FIG. 1 illustrates an exemplary embodiment of a wireless communication device according to the present invention.

FIG. 2 illustrates an example of a handover method of NFC.

FIG. 3a illustrates an exemplary exchange of a Wi-Fi P2P Handover Request message and a Wi-Fi P2P Handover Select Message.

FIG. 3b illustrates an exemplary configuration of a Wi-Fi P2P Handover Request Message.

FIG. 4 illustrates an exemplary configuration of an Alternative Carrier Record of a Wi-Fi P2P Handover Request Message.

FIG. 5 illustrates an exemplary configuration of a P2P Handover Carrier Record of a Wi-Fi P2P Handover Request Message.

FIG. 6 illustrates an exemplary configuration of a WSC Handover Carrier Record of a Wi-Fi P2P Handover Request Message.

FIG. 7 illustrates an exemplary structure of carrier data (CARRIER DATA) of a P2P Handover Carrier Record shown in FIG. 6.

FIG. 8 illustrates an exemplary format of a P2P connection Handover Attribute according to the present invention.

FIG. 9 illustrates a table showing exemplary identifiers (IDs) of the P2P connection Handover Attribute according to the present invention.

FIG. 10 illustrates an exemplary configuration of an Activation Timeout Attribute according to the present invention.

FIG. 11 illustrates an exemplary configuration of a GON Channel Attribute according to the present invention.

FIG. 12 illustrates an exemplary configuration of an Associated BSSID Attribute according to the present invention.

FIG. 13 illustrates an exemplary configuration of an Associated Channel Attribute according to the present invention.

FIG. 14 illustrates an exemplary structure of carrier data (CARRIER_DATA) of a WSC Handover Carrier Record.

FIG. 15 illustrates an exemplary structure of a Wi-Fi P2P Handover Select Message according to the present invention.

FIG. 16 illustrates an exemplary structure of a payload of a P2P Handover Carrier being included in the Wi-Fi P2P Handover Select Message according to the present invention.

FIG. 17 illustrates an exemplary structure of carrier data (CARRIER DATA) of a WSC Handover Carrier Record of the Wi-Fi P2P Handover Select Message.

FIG. 18 illustrates an exemplary embodiment of executing Connection Handover via Wi-Fi P2P in NFC by using a Wi-Fi P2P connection Handover Message according to the present invention.

FIG. 19 illustrates another exemplary embodiment of executing Connection Handover via Wi-Fi P2P in NFC by using a Wi-Fi P2P connection Handover Message according to the present invention.

FIG. 20 illustrates yet another exemplary embodiment of executing Connection Handover via Wi-Fi P2P in NFC by using a Wi-Fi P2P connection Handover Message according to the present invention.

FIG. 21 illustrates an exemplary embodiment of executing Connection Handover via Wi-Fi P2P in NFC by using a Wi-Fi P2P connection Handover Message according to the present invention.

FIG. 22 illustrates an operation flow chart when using a Wi-Fi P2P connection Handover Message according to the present invention.

### BEST MODE FOR CARRYING OUT THE PRESENT INVENTION

The exemplary embodiment of the present invention will hereinafter be described in detail with reference to the accompanying drawings.

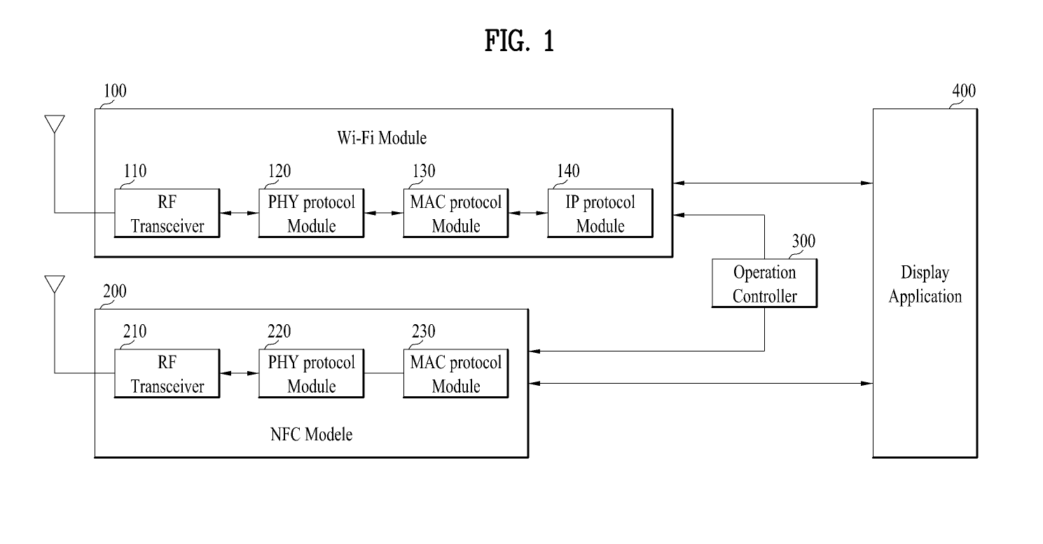

FIG. 1 illustrates an exemplary embodiment of a wireless communication device according to the present invention.

An exemplary embodiment of a wireless communication device according to the present invention includes a first communication module (100), a second communication module (200), a controller (300), and a display application (400). In this drawing, the first communication module (100) shows an example of a module performing communication in accordance with a Wi-Fi (wireless fidelity) system, and the second communication module (200) shows an example of a module performing communication in accordance with a NFC (Near Field Communication) method.

The communication module (100) may include a RF transceiver (110), a physical layer processing unit (PHY protocol Module) (120), and a MAC layer processing unit (MAC protocol Module) (130), and an IP layer processing unit (IP protocol Module) (140). Each of these functional blocks is used for transmitting and receiving (or transceiving) wireless data (or radio data) in accordance with the Wi-Fi method.

The second communication module (200) may include a RF transceiver (210), a physical layer processing unit (PHY protocol Module) (220), and a MAC layer processing unit (MAC protocol Module) (330). Each of the above-described elements included in the second communication module (200) may be used for transmitting and receiving (or transceiving) wireless data (or radio data) in accordance with the NFC method.

The RF transceiver (110) of the first communication module (100) and the RF transceiver (210) of the second communication module (200) each converts data being outputted from the PHY protocol modules (120, 220) of each module to respective RF band signals, and, then, after performing filtering and amplification, and so on, on the converted RF band signals, the RF transceivers (110, 210) transmits the processed signals to respective antennae. Additionally, each of the RF transceiver (110) of the first communication module (100) and the RF transceiver (210) of the second communication module (200) converts RF band signals, which are received from each of the respective antennae, to a signal band that can be processed by the PHY protocol Modules (120, 220) of each communication module (100, 200), and each of the RF transceivers (110, 210) performs filtering, and so on, on RF band signals in order to perform such conversion. Each of the RF transceiver (110) of the first communication module (100) and the RF transceiver (210) of the second communication module (200) may also include a switching function for shifting transmitting and receiving functions.

The PHY protocol Module (120) of the first communication module (100) and the PHY protocol Module (220) of the second communication module (200) may each have FEC encoding and modulation, and so on, performed on the transmitted data in each of the communication modules (100, 200), and, by inserting preamble and pilot signals, and so on, as supplemental signals, the processed data may be outputted to each of the RF transceivers (110, 210) respective to each of the communication modules (100, 200). In order to perform the above-described functions, the PHY protocol Module (120) of the first communication module (100) and the PHY protocol Module (220) of the second communication module (200) may include a modulator, a demodulator, an equalizer, a FEC encoder, a FEC decoder, and so on.

The PHY protocol Module (120) of the first communication module (100) and the PHY protocol Module (220) of the second communication module (200) each performs demodulation, equalization, error correction decoding (FEC decoding), and so on, on the received signals, which are respectively outputted from the RF transceivers (110, 210) of each communication module (100, 200), and, then, after removing the added supplemental signals from the physical layer (PHY), the PHY protocol Modules (120, 220) may output the processes signals to the respective MAC protocol modules (130, 230).

The MAC protocol modules (130, 230) of the first communication module (100) and the second communication module (200) each performs data processing in order to deliver higher-layer data to the physical layer (PHY). In order to do so, the MAC protocol modules (130, 230) each has the transmitted data respectively processed by each communication module (100, 200), and, then, after sending the processed data to each PHY protocol module (110, 220), each of the MAC protocol modules (130, 230) performs the function of delivering the received data, which are respectively processed by each of the PHY protocol modules (110, 220), to a higher layer. Thereafter, in order to perform such functions, the MAC protocol Modules (130, 230) each performs signal processing in accordance with a supplemental communication protocol.

The IP protocol Module (140) of the first communication module (100) processes data that are to be transmitted in accordance with an IP protocol and, then, outputs the processed data to the MAC protocol Module (130), and, then, after processing the data received from the MAC protocol Module (130) in accordance with the IP protocol, the IP protocol Module (140) outputs the processed data.

The controller (operation) (300) may control operations of the first communication module (100) and the second communication module (200) in accordance with operations wanted by the user

As a block configured to execute an application for performing display, the display application (400) allows a display function, which is wanted by the user, to be selected by performing interaction with the user, and, then, the display application (400) performs a function of initializing the corresponding function.

As an exemplary embodiment of the present invention, an exemplary embodiment for sharing content and for easily controlling its display, wherein two or more wireless data communication devices respectively uses two communication modules, when content is shared by using a first communication module, by having metadata of the corresponding content transmitted and received (or transceived) by using a second communication module before sharing and displaying the content by using the first communication module, will hereinafter be disclosed.

Additionally, according to another exemplary embodiment of the present invention, in case two wireless data communication devices are directly connected to one another by using the first communication module, an exemplary embodiment of transmitting and receiving (or transceiving) a connection Attribute between the two devices with respect to each of connection cases will be disclosed.

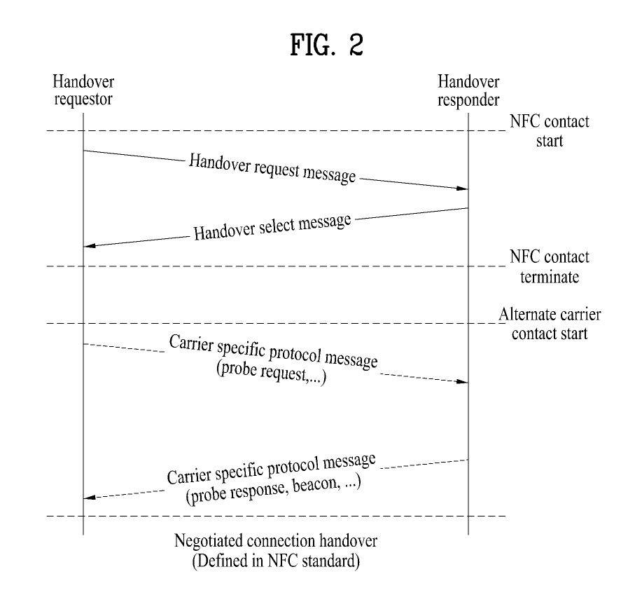

FIG. 2 illustrates an example of a handover method of NFC.

Handover may be performed by having a handover requesting device (Handover Requestor) and a handover responding device (Handover Responder) communication with one another by using a Negotiated Connection Handover of NFC.

In case the Handover Requestor and the Handover Responder are connected to one another via NFC, the Handover Requestor transmits a Handover Request Message to the Handover Responder. In response to such request, the Handover Responder transmits a Handover Select Message to the Handover Requestor. After exchanging information that is required for a Connection Handover with another carrier by performing the above-described two-way message transaction the corresponding NFC connection may be ended (or terminated) and connection may be re-established with the newly changed carrier.

In case the Handover Requestor and the Handover Responder are connected to one another through the newly changed carrier, the Handover Requestor and the Handover Responder may transmit and receive carrier specific protocol messages to and from one another, and, by using such Connection Handover Mechanism, information request for Wi-Fi direct P2P may also be transmitted and received (or transceived).

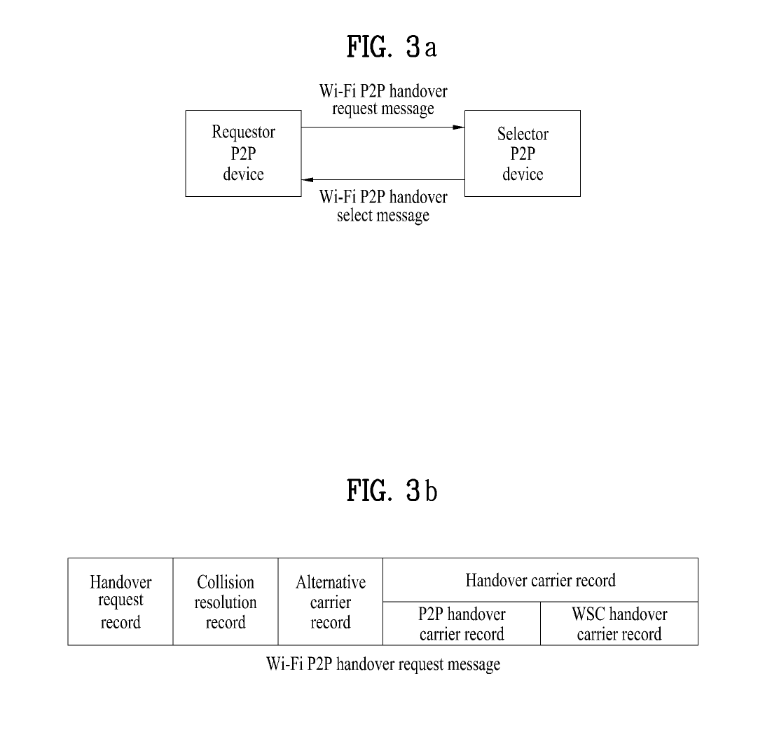

FIG. 3a illustrates an exemplary exchange of a Wi-Fi P2P Handover Request message and a Wi-Fi P2P Handover Select Message.

In order to request for a handover, a Requestor P2P Device may transmit a Wi-Fi P2P Handover Request Message to a Selector P2P Device. As a response to such request, the Selector P2P Device may transmit a Wi-Fi P2P Handover Select Message to the Requestor P2P Device. Hereinafter, configurations of the Wi-Fi P2P Handover Request Message and the Wi-Fi P2P Handover Select Message will be described in detail.

FIG. 3b illustrates an exemplary configuration of a Wi-Fi P2P Handover Request Message.

The Wi-Fi P2P Handover Request Message includes a Handover Request Record, a Collision Resolution Record, an Alternative Carrier Record, and a Handover Carrier Record. The Handover Carrier Record may include a P2P Handover Carrier Record and a WSC (Wi-Fi Simple Configuration) Handover Carrier Record.

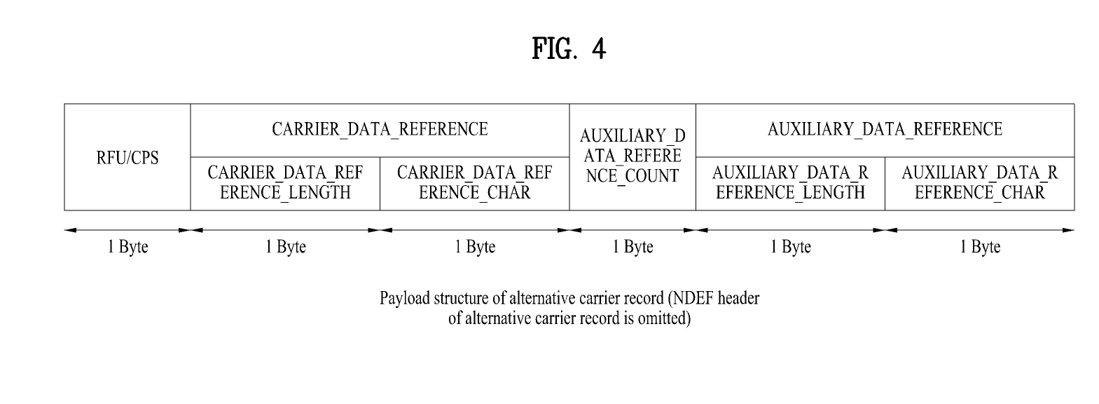

FIG. 4 illustrates an exemplary configuration of an Alternative Carrier Record of a Wi-Fi P2P Handover Request Message.

In FIG. 4, a NDEF (NFC Data Exchange Format) header (NDEF Header) of the Alternative Carrier Record has been omitted.

In FIG. 4, as a field being Reserved for Future Use, a RFU field indicates the higher 6 bits of RFU/CPS (Carrier Power Status). In case the CPS field is equal to 0×0, this indicates that an alternative carrier for Wi-Fi P2P is in an inactive state. Additionally, in case the CPS field is equal to 0×1, this indicates that the alternative carrier is in an active state, in case the CPS field is equal to 0×2, this indicates that the alternative carrier is in an activating state, and, in case the CPS field is equal to 0×3, this indicates that the alternative carrier is in an unknown state.

A carrier data reference (CARRIER_DATA_REFERENCE) corresponds to a pointer indicating the NDEF record, which represents information on an alternative carrier. The carrier data reference (CARRIER_DATA_REFERENCE) may include a carrier data reference length (CARRIER_DATA_REFERENCE_LENGTH) and a carrier data reference CHR (CARRIER_DATA_REFERENCE_CHAR).

An auxiliary data reference (AUXILIARY_DATA_REFERENCE) corresponds to a pointer indicating the NDEF record, which represents supplemental information respective to the alternative carrier. The auxiliary data reference (AUXILIARY_DATA_REFERENCE) may include a carrier data reference length (CARRIER_DATA_REFERENCE_LENGTH) and a carrier data reference CHR (CARRIER_DATA_REFERENCE_CHAR).

The NDEF message according to the present invention may perform P2P Wi-Fi connection via NFC by mapping the NDEF record representing information on P2P to the CARRIER_DATA_REFERENCE and by mapping the NDEF record representing WSC information for performing P2P authentication (or certification) to the AUXILIARY_DATA_REFERENCE.

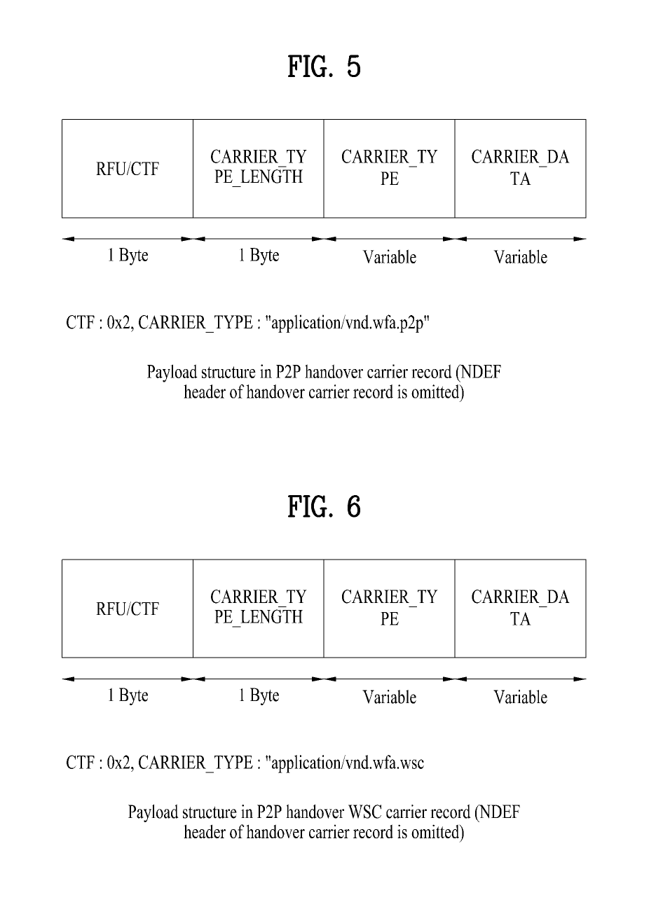

FIG. 5 illustrates an exemplary configuration of a P2P Handover Carrier Record of a Wi-Fi P2P Handover Request Message.

A P2P Handover Carrier Record may include a 1-byte RFU/CTF, a 1-byte Carrier

Type Length, Carrier Type, and Carrier Data. Meanwhile, in FIG. 5, a NDEF header of a Handover Carrier Record has been omitted. A TNF field of the NDEF header may be set to 0×01, and a Payload Type Name of the NDEF header may be set to “Hc” (0×48, 0×63).

The RFU field represents the higher 5 bits of the RFU/CTF. And, as the lower 3 bits of the RFU/CTF, CTF represents a structure of the Carrier Type field (CARRIER_TYPE field). In case the CTF value is equal to 1, the carrier type corresponds to a NFC Forum well-known type, in case the CTF value is equal to 2, the carrier type corresponds to a Media-type as defined RFC 2046 (MIME), in case the CTF value is equal to 3, the carrier type corresponds to an Absolute URI as defined RFC 3986, and, in case the CTF value is equal to 4, the carrier type corresponds to a NFC Forum external type. In the present invention, in order to perform Wi-Fi P2P by using the NFC, the CTF value is set to 2.

The Carrier Type Length (CARRIER_TPYE_LENGTH) indicates the length of the carrier type in byte units. The Carrier Type field (CARRIER_TYPE field) corresponds to a field that delivers unique information respective to an alternative carrier, and, herein, its structure, encoding, format, and so on, are decided by the above-described CTF. In the present invention, since the CTF is set to the MIME (Multipurpose Internet Mail Extensions) type, the Carrier Type (CARRIER_TYPE) should be defined as a MIME for representing Wi-Fi P2P. In the present invention, this will be defined as “application/vnd.wa.pp”. P2P attributes, which are defined in a Wi-Fi P2P Technical Specification, and a P2P vendor specific attribute, which is newly defined in the present invention for a P2P connection set-up by using NFC, are used in the Carrier Data (CARRIER_DATA).

FIG. 6 illustrates an exemplary configuration of a WSC Handover Carrier Record of a Wi-Fi P2P Handover Request Message.

A WSC Handover Carrier Record may include a 1-byte RFU/CTF, a 1-byte Carrier Type Length, Carrier Type, and Carrier Data. Meanwhile, in FIG. 6, a NDEF header of a Handover Carrier Record has been omitted. A TNF field of the NDEF header may be set to 0×01, and a Payload Type Name of the NDEF header may be set to “Hc” (0×48, 0×63).

The RFU field represents the higher 5 bits of the RFU/CTF. And, as the lower 3 bits of the RFU/CTF, CTF represents a structure of the Carrier Type field (CARRIER_TYPE field). In case the CTF value is equal to 1, the carrier type corresponds to a NFC Forum well-known type, in case the CTF value is equal to 2, the carrier type corresponds to a Media-type as defined RFC 2046 (MIME), in case the CTF value is equal to 3, the carrier type corresponds to an Absolute URI as defined RFC 3986, and, in case the CTF value is equal to 4, the carrier type corresponds to a NFC Forum external type. In the present invention, in order to perform Wi-Fi P2P by using the NFC, the CTF value is set to 2.

The Carrier Type Length (CARRIER_TPYE_LENGTH) indicates the length of the carrier type in byte units. The Carrier Type field (CARRIER_TYPE field) corresponds to a field that delivers unique information respective to an alternative carrier, and, herein, its structure, encoding, format, and so on, are decided by the above-described CTF. In the present invention, since the CTF is set to the MIME (Multipurpose Internet Mail Extensions) type, the Carrier Type (CARRIER_TYPE) should be defined as a MIME for representing Wi-Fi P2P. In the present invention, this will be defined as “application/vnd.wa.pp”. WSC attributes, which are defined in a WSC technical specification (Wi-Fi Simple Configuration Technical Specification), are used in the Carrier Data (CARRIER_DATA).

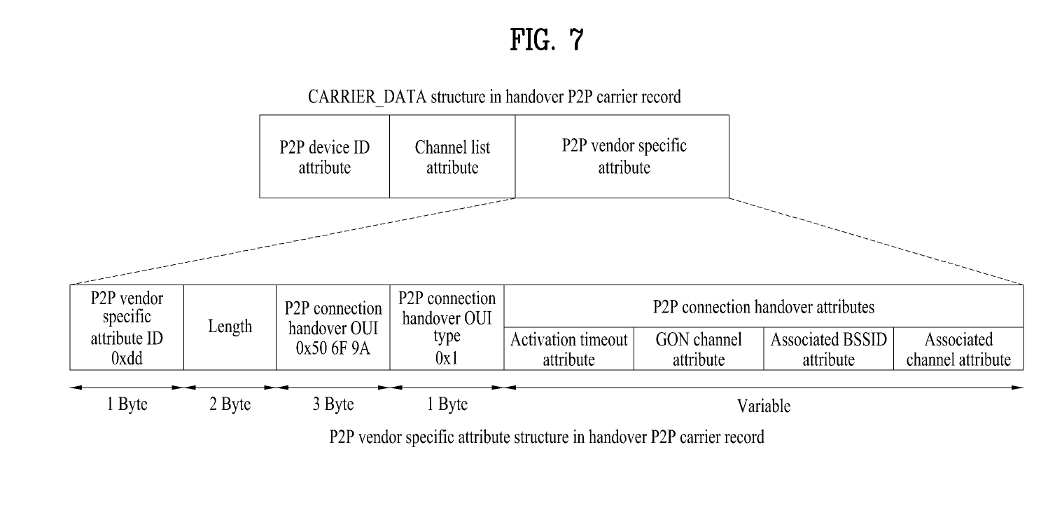

FIG. 7 illustrates an exemplary structure of carrier data (CARRIER_DATA) of a P2P Handover Carrier Record shown in FIG. 6.

Among the P2P attributes that are defined in a Wi-Fi P2P Technical Specification, the Carrier Data (CARRIER_DATA) may include a P2P Device ID Attribute, and a Channel List attribute.

As an attribute indicating its own MAC address, the P2P Device ID Attribute is used for displaying (or indicating) an identity of a device when performing Wi-Fi P2P network set-up (or when setting up Wi-Fi P2P network configuration).

Among the channels that can be supported by the current device, the Channel List attribute represents a list of channels that can set up P2P connection.

The attributes that are added in the present invention are included in a P2P Vendor Specific Attribute, which is defined in the Wi-Fi P2P Technical Specification. A P2P Vendor Specific Attribute ID has been defined as Oxdd in the Wi-Fi P2P Technical Specification. In order to indicate a data length of a field subsequent to the identifier (ID), a field having the length of 2 bytes is used. Thereafter, in order to indicate that the data correspond to data respective to P2P connection Handover, a new P2P connection Handover OUI (Organizationally Unique Identifier) is defined. Additionally, in order to indicate a version of subsequent data, a 1-byte field of a P2P connection Handover OUI Type is defined. Subsequently, the P2P connection Handover Attributes, which are defined in the present invention, are added to the P2P Vendor Specific attribute.

The P2P Vendor Specific attribute according to the present invention may include P2P connection Handover Attributes, such as an Activation Timeout Attribute, a GON (Group Owner Negotiation) Channel Attribute, an Associated BSSID (Basic Service Set IDentifier) Attribute, an Associated Channel Attribute, and so on. The Activation Timeout Attribute indicates a time that is required for turning on the Alternative Carrier. The GON Channel Attribute exchanges messages that are required for the Wi-Fi P2P Connection over the NFC and then defines a channel through which data are to be actually transmitted and received to and from one another over Wi-Fi. The Associated BSSID Attribute indicates that the device is currently connected to an infra-structure AP or a P2P GO (Group Owner). The Associated Channel Attribute indicates associated channel information, in case an Association is established.

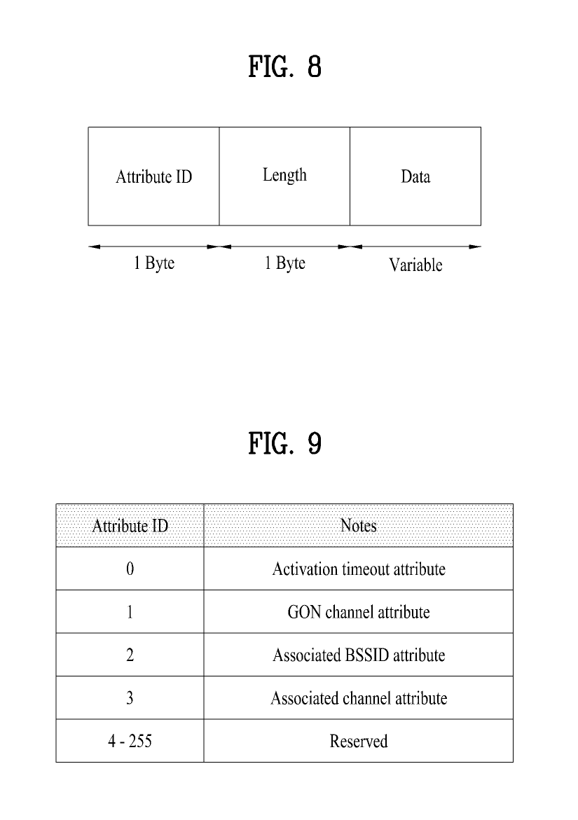

FIG. 8 illustrates an exemplary format of a P2P connection Handover Attribute according to the present invention.

The P2P connection Handover Attribute consists of a 1-byte Attribute ID, a Length field indicating the length of subsequent data, and a Data field.

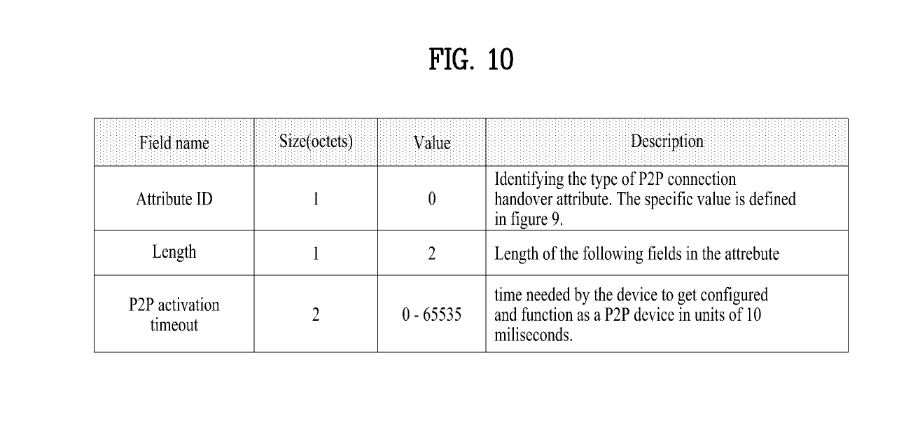

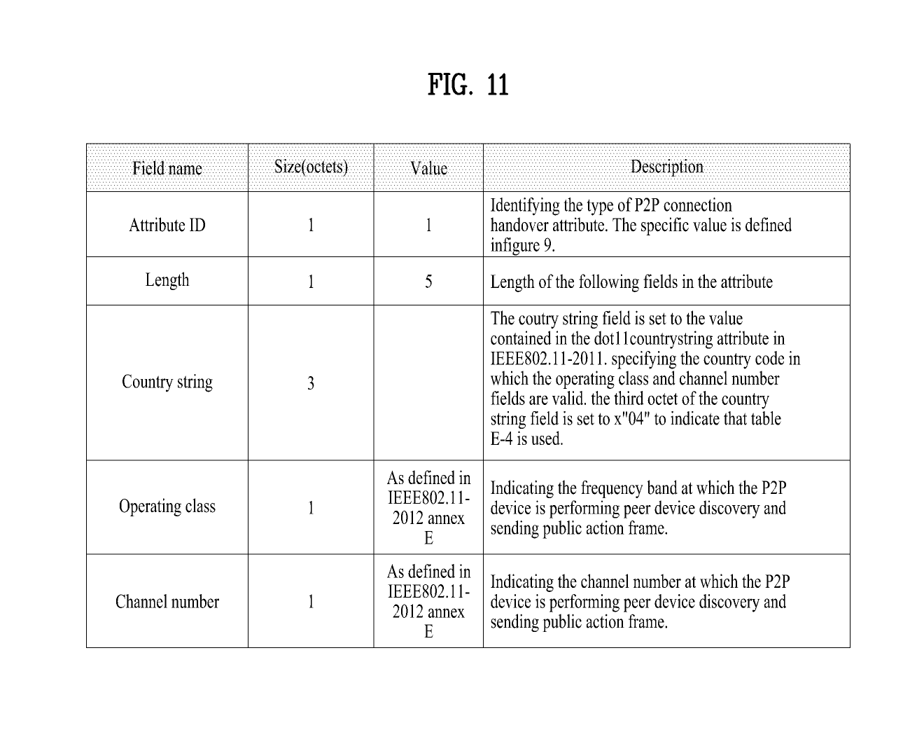

FIG. 9 illustrates a table showing exemplary identifiers (IDs) of the P2P connection Handover Attribute according to the present invention.

The Activation Timeout Attribute is marked as ID 0, the GON Channel Attribute is marked as ID 1, the Associated BSSID Attribute is marked as ID 2, the Associated Channel Attribute is marked as ID 3, and IDs 4 to 255 are kept in reservation.

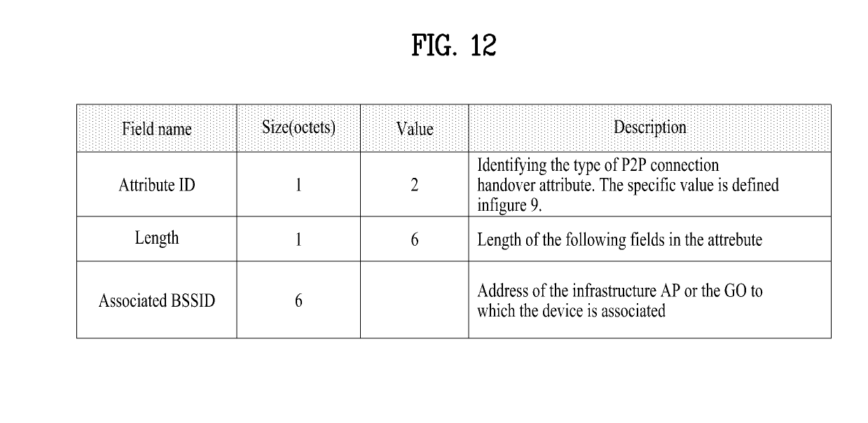

FIG. 10 illustrates an exemplary configuration of an Activation Timeout Attribute according to the present invention.

The P2P Activation Timeout field has a length of 2 bytes, and this attribute indicates a time that is consumed for activating (or turning on) a Wi-Fi P2P interface after the exchange of NFC connection handover message, and the unit of this attribute is 10 ms. In case the CPS field of the Alternative Carrier Record of FIG. 4 is equal to 1 (Active), the P2P Activation Timeout field is set to 0. In case the CPS is equal to 2 (Activating), this field indicates the time that is consumed for completely (or fully) turning on the Wi-Fi P2P interface. In case the CPS is equal to 3 (Unknown), this value is not valid.

FIG. 11 illustrates an exemplary configuration of a GON Channel Attribute according to the present invention.

The GON Channel Attribute indicates information on a channel, which is scheduled to transmit a P2P Public Action frame, which is defined in the Wi-Fi P2P Technical Specification, or a Class 1 frame, which is defined in IEEE802.1, and so on, after the exchange of NFC connection handover message. For example, a Country String field may be configured (or set up) to include a country string field of IEEE802.1, wherein an Operating Class and a Channel Number are valid. The Operating Class indicates a frequency band through which the P2P device transmits the Public Action Frame. The Channel Number indicates a number of channels used by the P2P device for transmitting the Public Action Frame.

FIG. 12 illustrates an exemplary configuration of an Associated BSSID Attribute according to the present invention.

The Associated BSSID Attribute indicates that the current device is in association with an infra-structure AP or a P2P GO (Group Owner).

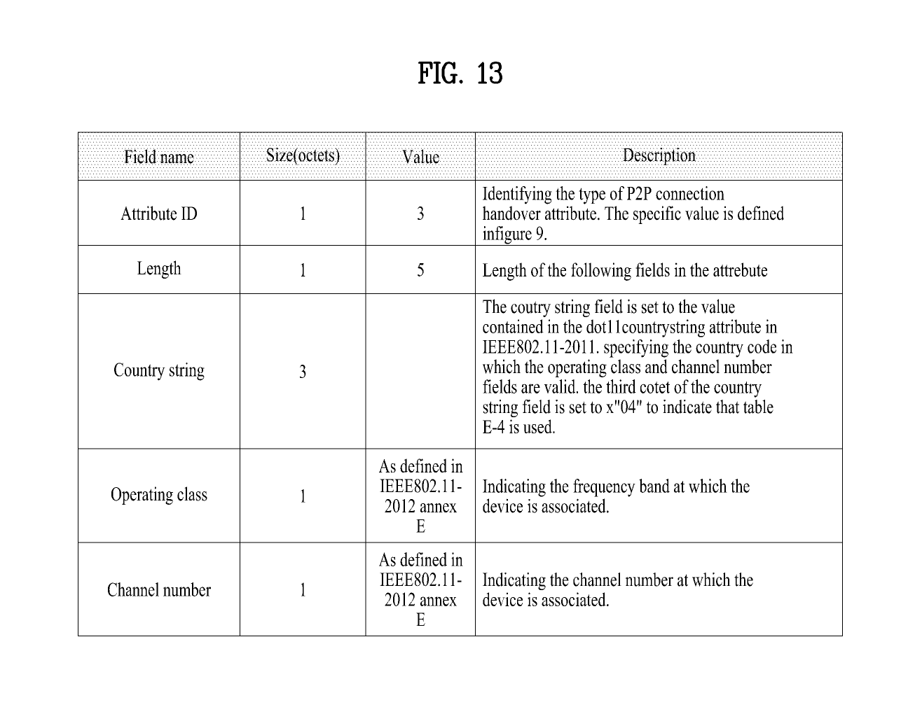

FIG. 13 illustrates an exemplary configuration of an Associated Channel Attribute according to the present invention.

When the current device is in association with an infra-structure AP or a P2P GO (Group Owner), the Associated Channel Attribute indicates information on the associated channel. For example, a Country String field may be configured (or set up) to include a country string field of IEEE802.1, wherein an Operating Class and a Channel Number are valid. The Operating Class indicates a frequency band that is associated with the P2P device. The Channel Number indicates a number of channels being associated with the P2P device.

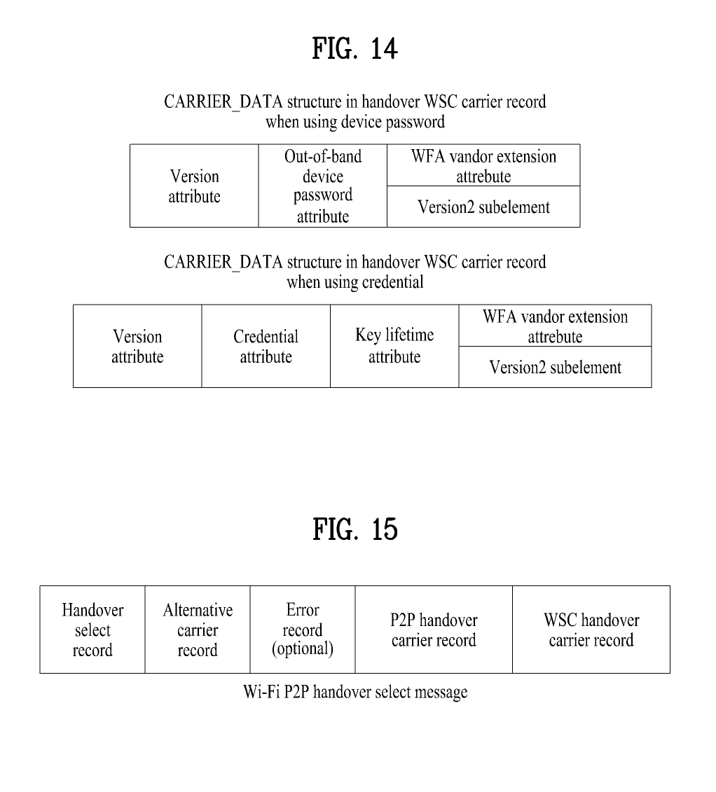

FIG. 14 illustrates an exemplary structure of carrier data (CARRIER DATA) of a WSC Handover Carrier Record.

When a device that is to establish (or set up) Wi-Fi P2P by using a NFC delivers a Wi-Fi P2P connection Handover Request message, the device may share a Device Password with other devices by transmitting a Device Password, which is defined in the WSC (Wi-Fi Simple Configuration) specification. In case the Device Password is used, a Carrier Data (CARRIER_DATA) portion of a WSC Carrier record includes a Version Attribute, which is defined in the WSC, an Out-of-Band Device Password attribute, and a WFA (Wi-Fi Alliance) Vendor Extension Attribute including a Version2 sub-element. Two devices sharing the Device Password may share Credential through the WSC when establishing Wi-Fi P2P connection.

Additionally, credential may be shared among devices by transmitting the Credential, and, in this case, when establishing Wi-Fi P2P connection, inter-device (or P2P) connection may be directly established without having to perform the WSC. In case of using the Credential, which is defined in the WSC, a Carrier Data (CARRIER_DATA) portion of a WSC Carrier record includes a Version Attribute, which is defined in the WSC, a Credential Attribute including Credential information that is to be used when the corresponding device has become the GO, a Key Lifetime Attribute, and a WFA Vendor Extension Attribute including a Version2 sub-element.

When a device receiving a Wi-Fi P2P connection Handover Request message including the Device Password seeks to use a new Device Password, the corresponding device may transmit a wanted Device Password to the Wi-Fi P2P connection Handover Select message. Additionally, in order to use the initial Device Password, the WSC Carrier record includes the Version Attribute and the WFA Vendor Extension Attribute including a Version2 sub-element in the Wi-Fi P2P connection Handover Select message.

The device receiving the Wi-Fi P2P connection Handover Request message including the Device Password cannot include Credential information in the WSC Handover Carrier Record of the Wi-Fi P2P connection Handover Select message. At the time of transmitting and receiving to and from one another over the NFC, since it is not decided as to which device is to become the GO, a device that has received a Wi-Fi P2P Connection Request message including Credential must include the Credential in the respective Wi-Fi P2P Connection Select message. In case the Wi-Fi P2P Connection Request/Select message includes Credential, a SSID (Service Set Identifier) is required to use “Direct-”, which corresponds to a P2P Wildcard SSID.

Additionally, in case a passphrase (a case when a Network Key corresponds to 8˜63 ascii characters) has been used from the Credential, a network key shall be generated by using the SSID, which is defined after configuring the corresponding passphrase and its subsequent Wi-Fi P2P link, and by using a PBKDF2 functions, which is defined in the IEEE802.1 specification (or standard). Alternatively, in case a Network key (a case when the Network Key corresponds to 64 hex characters), the network key is used without performing any PBKDF2 operations (or calculations).

FIG. 15 illustrates an exemplary structure of a Wi-Fi P2P Handover Select Message according to the present invention.

When it is required to indicate an Error status respective to a Handover Select record, an Alternative Carrier Record, and a Wi-Fi P2P Handover Request message, which are defined in the NFC Forum, an Error Record is included in a Wi-Fi P2P Handover Select message. In case an Error does not occur, the Error Record is omitted. Furthermore, the Wi-Fi P2P Handover Select message includes the P2P Handover Carrier record and the WSC Handover Carrier record according to the present invention.

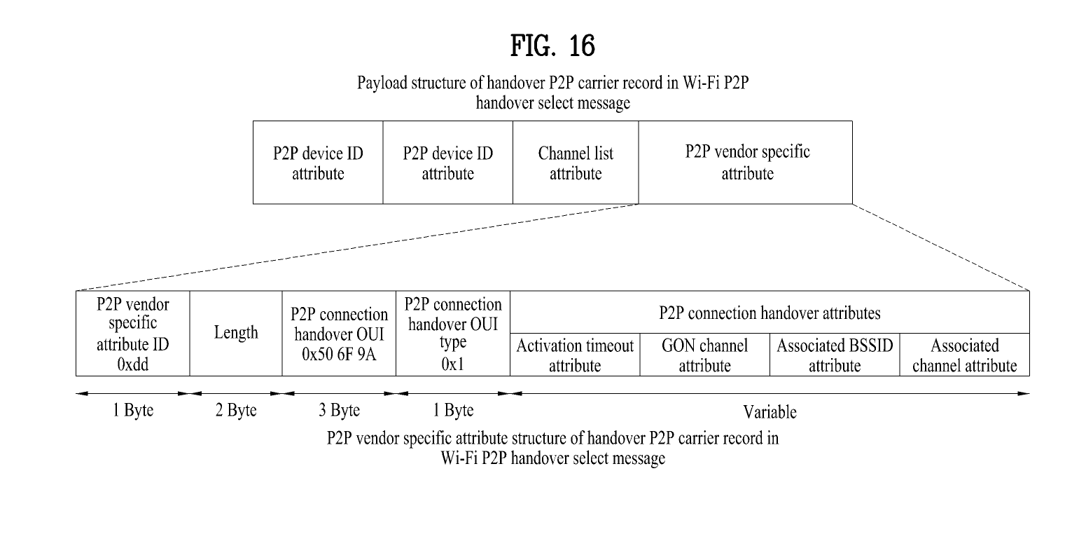

FIG. 16 illustrates an exemplary structure of a payload of a P2P Handover Carrier being included in the Wi-Fi P2P Handover Select Message according to the present invention.

As compared to the payload of the P2P Handover Carrier, which is included in the Wi-Fi P2P Handover request message, a Status Attribute, which is defined in the Wi-Fi P2P Specification, has been added. This corresponds to an attribute that indicates whether or not the received Wi-Fi P2P Connection Handover message has been successfully processed, and, in case the Status code of the Status Attribute is 0 (Success), the two devices that have transmitted and received the Wi-Fi P2P Handover Request/Select message to and from one another may perform Wi-Fi P2P Group formation in a channel defined by the GON Channel Attribute. In case the Status code is not 0, the two devices may create (or form) a new Wi-Fi P2P Group by transmitting and receiving a new Wi-Fi P2P Handover Request/Select message to and from one another.

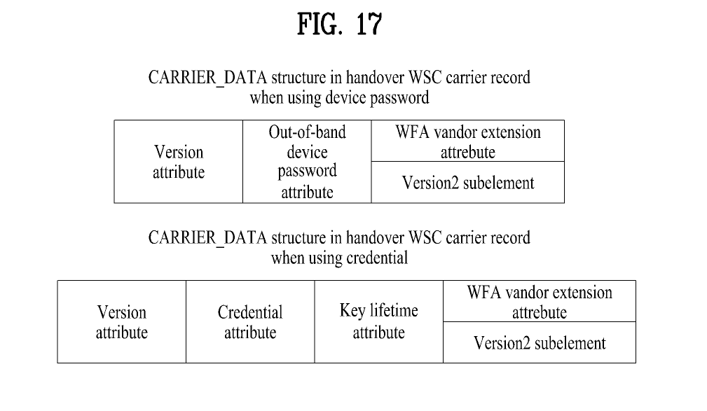

FIG. 17 illustrates an exemplary structure of carrier data (CARRIER DATA) of a WSC Handover Carrier Record of the Wi-Fi P2P Handover Select Message.

In case of receiving a Wi-Fi P2P connection Handover Request message including the Device Password, which is defined in the WSC (Wi-Fi Simple Configuration) Specification, a Wi-Fi P2P Handover Select message is required to be transmitted as a response to the received request message, and, at this point, in order to use a new Device Password among the devices a new Out-of-Band Device Password Attribute, a Version Attribute, and a WFA Vendor Extension Attribute including a Version2 sub-element are required to be included in the WSC Handover Carrier Record. In case of using the Device Password, which is included in the Wi-Fi P2P connection Handover Request message, the Wi-Fi P2P Handover Select message is required to be transmitted by including the Version Attribute and the WFA Vendor Extension Attribute including the Version2 sub-element in the WSC Handover Carrier Record.

In case of receiving a Wi-Fi P2P connection Handover Request message including a Credential, which is defined in the WSC (Wi-Fi Simple Configuration) Specification, a Wi-Fi P2P connection Handover Select message is required to be transmitted as a response to the received request message, and, in this case, a Version Attribute, a WFA Vendor Extension Attribute including a Version2 sub-element, a Credential Attribute including Credential information that is to be used when the corresponding device becomes the GO, and a Key Lifetime Attribute are required to be included in the WSC Handover Carrier Record. In case the Credential is included in the Wi-Fi P2P Connection Select message, a SSID is required to use “Direct-”, which corresponds to a P2P Wildcard SSID. Additionally, in case a passphrase (a case when a Network Key corresponds to 8˜63 ascii characters) has been used from the Credential, a network key shall be generated by using the SSID, which is defined after configuring the corresponding passphrase and its subsequent Wi-Fi P2P link, and by using a PBKDF2 functions, which is defined in the IEEE802.1-2012 specification (or standard). Alternatively, in case a Network key (a case when the Network Key corresponds to 64 hex characters), the network key is used without performing any PBKDF2 operations (or calculations).

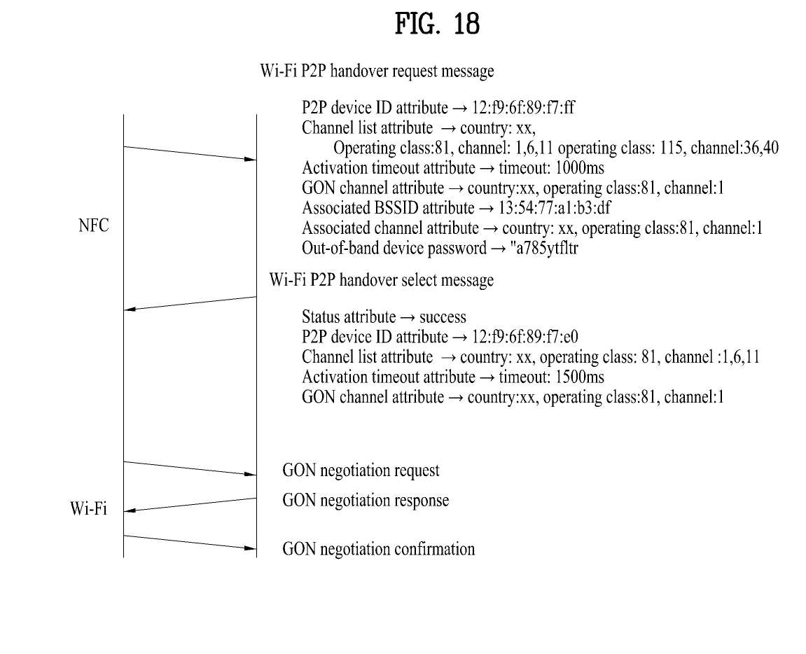

FIG. 18 illustrates an exemplary embodiment of executing Connection Handover via Wi-Fi P2P in NFC by using a Wi-Fi P2P connection Handover Message according to the present invention.

In FIG. 18, the Version Attribute and the WFA Vendor Extension Attribute including the Version2 sub-element of the WSC Carrier record are omitted.

In FIG. 18, the Requestor sending out (or transmitting) the Wi-Fi P2P Handover Request message supports channel numbers 1, 6, and 11 and numbers 36 and 40. Additionally, 1000 ms are required for activating (or turning on) a Wi-Fi P2P interface after transmitting and receiving the NFC message. Channel number 1 is intended to be used as a channel that is to perform P2P GON (or P2P Invitation) after the Connection Handover, and “a785ytfltr” is intended to be used as the Device Password. After the Status Success, the Activation Timeout 1500 ms, and the Connection Handover, the device receiving the Wi-Fi P2P connection Handover Request message may be capable of transmitting the P2P connection Handover Select message by using channel number 1 as the channel that is to perform P2P GON (or P2P Invitation). At this point, since the device transmitting the P2P connection Handover Select message shares the Device Password, which is transmitted by the Request message, an Out-of-Band Device Password is not required to be included in the Select message. After exchanging messages, and after an Activation Timeout of each device has elapsed, each of the devices performs P2P GON (or P2P Invitation) in Channel number 1, which is set up as described above. At this point, the device that has transmitted the Wi-Fi P2P Handover Request message is required to transmit a P2P GON (or P2P Invitation) Request frame firsthand.

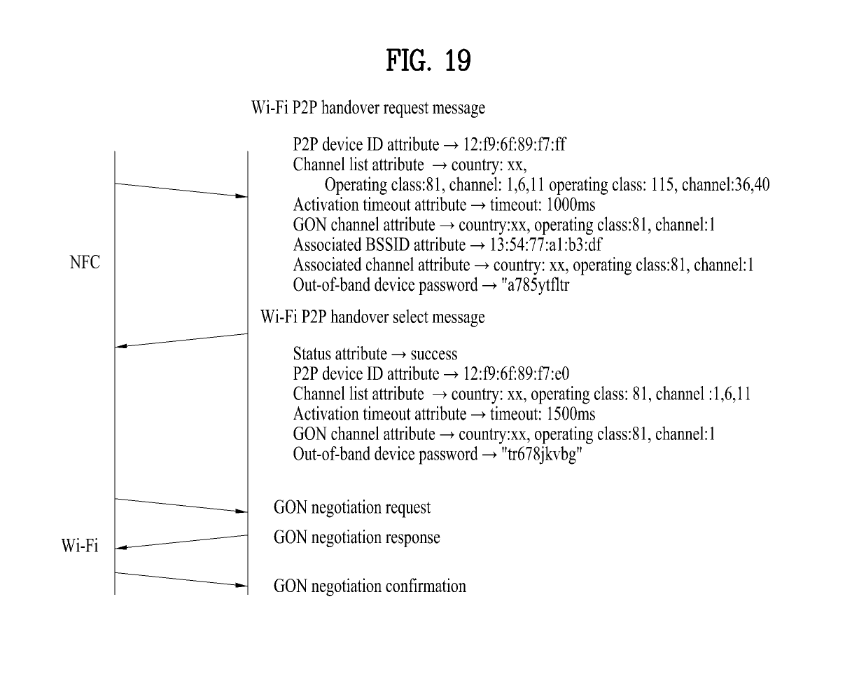

FIG. 19 illustrates another exemplary embodiment of executing Connection

Handover via Wi-Fi P2P in NFC by using a Wi-Fi P2P connection Handover Message according to the present invention.

In FIG. 19, the Version Attribute and the WFA Vendor Extension Attribute including the Version2 sub-element of the WSC Carrier record are omitted.

In FIG. 19, the device receiving the Wi-Fi P2P Handover Request message including an Out-of-Band Device Password wishes to use a new Device Password. Accordingly, when transmitting a Wi-Fi P2P Handover Select message, the Wi-Fi P2P Handover Select message is transmitted by adding an Out-of-Band Device Password including a new Device Password. At this point, the two devices are required to perform WSC by using the Device Password, which is transmitted by the Selector.

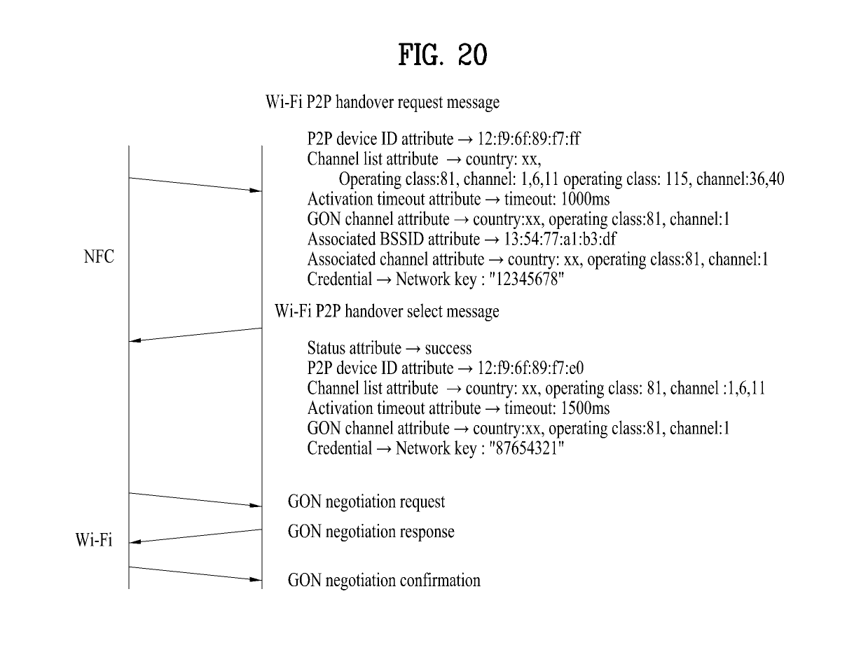

FIG. 20 illustrates yet another exemplary embodiment of executing Connection Handover via Wi-Fi P2P in NFC by using a Wi-Fi P2P connection Handover Message according to the present invention.

In FIG. 20, the Version Attribute and the WFA Vendor Extension Attribute including the Version2 sub-element of the WSC Carrier record are omitted.

In FIG. 20, the device that has received the Wi-Fi P2P Handover Request message including the Credential Attribute is required to transmit a Wi-Fi P2P Handover Select message, wherein a Credential Attribute, which includes Credential information that is to be used when the corresponding device has become the Group Owner, is added thereto. At this point, since the two devices share the same Credential information, a new BSS may be respectively formed (or created) without having to perform the WSC process.

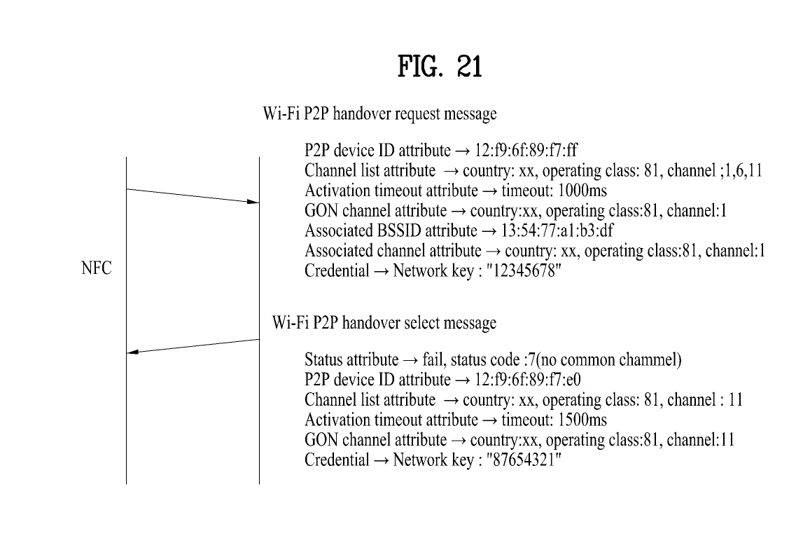

FIG. 21 illustrates an exemplary embodiment of executing Connection Handover via Wi-Fi P2P in NFC by using a Wi-Fi P2P connection Handover Message according to the present invention.

In FIG. 21, the Version Attribute and the WFA Vendor Extension Attribute including the Version2 sub-element of the WSC Carrier record are omitted.

In FIG. 21, the Requestor transmitting the Wi-Fi P2P Handover Request message supports only Channel number 1. However, since the Selector supports only Channel number 11, a common channel through which the two devices are to perform Wi-Fi P2P GON does not exist. Accordingly, the two devices eventually fail to perform Wi-Fi P2P Connection Handover.

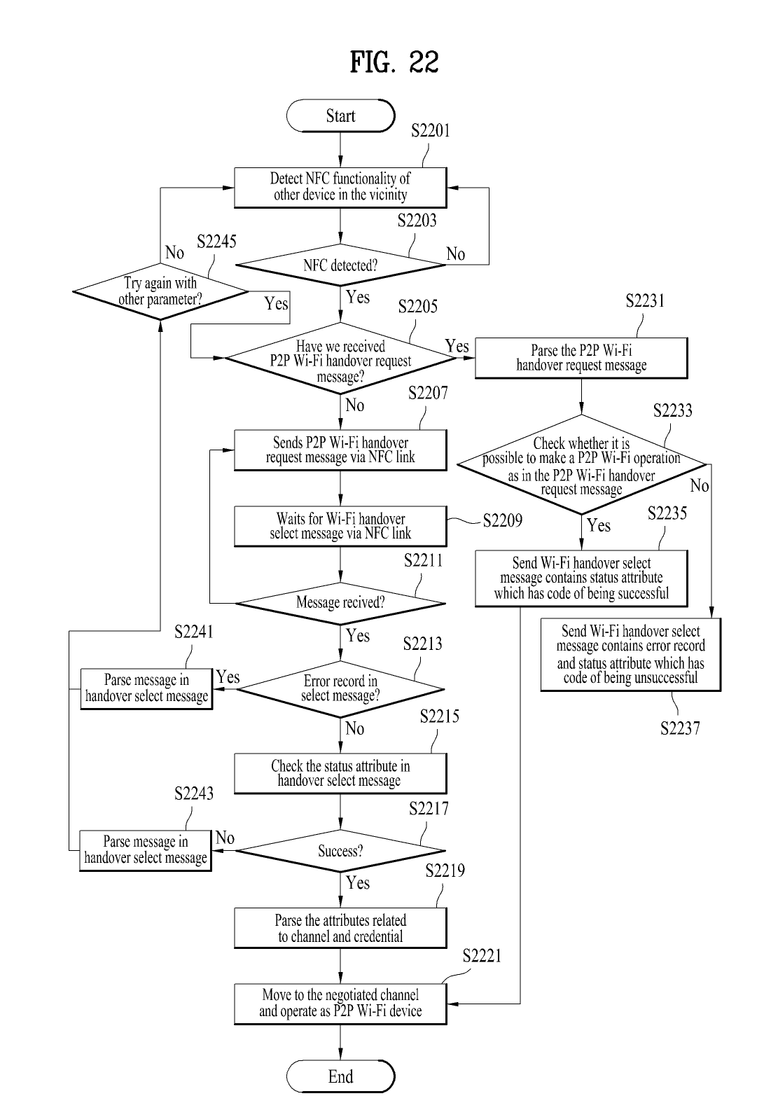

FIG. 22 illustrates an operation flow chart when using a Wi-Fi P2P connection Handover Message according to the present invention.

First of all, the wireless communication device detects (or searches for) a neighboring wireless communication device being equipped with a NFC function (S2201). When a neighboring wireless communication device equipped with the NFC function is detected (S2203), the wireless communication device verifies whether or not a Handover Request message is received from the neighboring wireless communication device (S2205). In case the Handover Request message is not received from the neighboring wireless communication device, the wireless communication device transmits a Handover Request message to the neighboring communication device through a NFC link (S2207). Thereafter, the wireless communication device waits (or stands-by) for the reception of a Handover Select message from the neighboring wireless communication device through the NFC link (S2209). When the Handover Select message is received (S2211), the wireless communication device verifies whether or not an error exists in the received Handover Select message (S2213). If an error does not exist, the wireless communication device verifies a Status Attribute in the Handover Select message (S2215). When the verification of the Status Attribute is performed successfully (S2217), attributes related to the channel and credential are analyzed (or parsed) (S2219). Subsequently, the wireless communication device establishes (or performs) a Wi-Fi P2P connection with the neighboring wireless communication device through a negotiated channel (S2221).

Meanwhile, in case the Handover Request message is received in step S2205, the Handover Request message is parsed (or analyzed) (S2231). Thereafter, the wireless communication device verifies whether or not a Wi-Fi P2P connection can be established with the neighboring wireless communication device in accordance with the Handover Request message (S2233). In case the Wi-Fi P2P connection can be established, the wireless communication device transmits a Wi-Fi Select message including a Status Attribute, which includes a code respective to the successful connection, and establishes (or performs) the Wi-Fi P2P connection (S2235). Conversely, in case the Wi-Fi P2P connection cannot be established, the wireless communication device transmits a Handover Select message including a code respective to the connection failure and an error record (S2237).

Meanwhile, in case an error code exists in step S2213, or in case a failure to verify a status attribute occurs in step S2217, the wireless communication device parses (or analyzes) the Handover Select message (S2241, S2243). Thereafter, when the wireless communication device attempts to perform the process once again by using another parameter, and when the attempt is successful, the device performs step S2205, and when the attempt fails, the device performs step S2201 (S2245).

According to the exemplary embodiment of the present invention, two wireless data communication devices available for communication connection, e.g., devices that can use both Wi-Fi P2P and NFC communication methods may perform Wi-Fi P2P connection setup (or connection establishment) via NFC. Accordingly, the time that is consumed for the Wi-Fi P2P connection setup may be reduced, and the Wi-Fi P2P connection setup may be efficiently performed.

### INDUSTRIAL APPLICABILITY

The exemplary embodiment of the present invention has an industrial applicability that can be used and repeatedly applied in the field of communication technology.

What is claimed is:

1. As a network connection method by which a first wireless communication device supporting a first networking system and a second networking system connects to a second wireless communication device, the network connection method comprises:
a step of transmitting, to the second wireless communication device supporting the first networking system, a handover request message for requesting for information in order to connect to the second networking system by using an out of band channel of the first networking system;
a step of receiving, from the second wireless communication device, provisioning information on an authorization for forming a group in the second networking system in response to the handover request message; and
a step of transmitting and receiving additional information for connecting the second networking system to the second wireless communication device according to information included in a handover select message.

2. The method of claim 1, wherein the Handover Select message further comprises:
channel information configured to decide a Group Owner in the second networking system.

3. The method of claim 1, wherein the provisioning information includes credential information authorizing the first wireless communication device to access the second wireless communication device.

4. The method of claim 1, wherein the provisioning information includes a device password.

5. The method of claim 1, wherein the first networking system includes a NFC (Near Field Communication) method, and wherein the second networking system includes a WiFi P2P method.

6. The method of claim 1, wherein the Handover Select message includes connection time information on a time consumed for a connection of the second networking system.

7. The method of claim 1, wherein the Handover Select message includes valid time information on a time period during which the provisioning information is valid.

8. The method of claim 1, wherein the Handover Select message further comprises:
channel information configured to form a group in the second networking system.

9. The method of claim 1, wherein the Handover Select message includes information on a Basic Service Set of a network to which the second wireless communication device is connected.

10. The method of claim 9, wherein the information on the Basic Service Set includes a MAC (Media Access Control) address of an owner device of the Basic Service Set.

11. As a first wireless communication device, which performs connection to a second wireless communication device, and which supports a first networking system and a second networking system, the first wireless communication device comprises:
a RF (Radio Frequency) unit; and
a processor,
wherein the processor is configured:
to transmit, to the second wireless communication device supporting the first networking system, a handover request message for requesting for information in order to connect to the second networking system by using an out of band channel of the first networking system, to receive, from the second wireless communication device, provisioning information on an authorization for forming a group in the second networking system in response to the handover request message, and
to transmit and receive additional information for connecting the second networking system to the second wireless communication device according to information included in a handover select message.

12. The device of claim 11, wherein the Handover Select message further comprises:
channel information configured to decide a Group Owner in the second networking system.

13. The device of claim 11, wherein the provisioning information includes credential information authorizing the first wireless communication device to access the second wireless communication device.

14. The device of claim 11, wherein the provisioning information includes a device password.

15. The device of claim 11, wherein the first networking system includes a NFC (Near Field Communication) method, and wherein the second networking system includes a WiFi P2P method.

16. The device of claim 11, wherein the Handover Select message includes connection time information on a time consumed for a connection of the second networking system.

17. The device of claim 11, wherein the Handover Select message includes valid time information on a time period during which the provisioning information is valid.

18. The device of claim 11, wherein the Handover Select message further comprises:
channel information configured to form a group in the second networking system.

19. The device of claim 11, wherein the Handover Select message includes information on a Basic Service Set of a network to which the second wireless communication device is connected.

20. The device of claim 19, wherein the information on the Basic Service Set includes a MAC (Media Access Control) address of an owner device of the Basic Service Set.
